(19) United States
(12) Patent Application Publication
(10) Pub. No.: US 2025/0373324 A1
(43) Pub. Date: Dec. 4, 2025

(54) MULTI-COORDINATION FOR NON-TERRESTRIAL GENERATED ENHANCED ANTENNA ARRAYS

(71) Applicant: T-MOBILE INNOVATIONS LLC, Overland Park, KS (US)

(72) Inventor: Akin OZOZLU, McLean, VA (US)

(21) Appl. No.: 18/676,039

(22) Filed: May 28, 2024

(51) Int. Cl. H04B 7/185

(52) U.S. Cl. CPC H04B 7/18521; H04B 7/18528; H04B 7/1853

(57) ABSTRACT

At a high level, the technology disclosed herein relates to multi-non-terrestrial device coordination for enhanced antenna array(s). In embodiments, an anchor non-terrestrial device (e.g., a satellite), capable of communicating with a user device, may identify a second non-terrestrial device. Based on identifying the second non-terrestrial device, the anchor non-terrestrial device may establish a link (e.g., a high speed laser link) with the second non-terrestrial device for receiving time and frequency data from the second non-terrestrial device, the time and frequency data being associated with the second non-terrestrial device and the user device. The anchor non-terrestrial device may perform decoding operations on the time and frequency data for the generation of a synchronized antenna array uplink for the user device. In embodiments, a data packet received from the user device via the synchronized antenna array uplink may be transmitted.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for multi-satellite coordination for generating enhanced antenna array(s). For example, the multi-satellite coordination discussed herein may include providing larger antenna arrays generated in non-terrestrial environments for the facilitation of enhanced and reliable communication services for user equipment (UEs)/user devices. The larger antenna array may be associated with frequency-division duplexing (FDD) communications. In embodiments, the larger antenna array has a higher uplink signal to interference plus noise ratio (SINR) than an associated individual uplink for each of the satellites associated with the multi-satellite coordination, a higher downlink SINR than the associated individual downlinks for each of the satellites associated with the multi-satellite coordination, or one or more combinations thereof.

In embodiments, two or more satellites (e.g., orbiting between about 300 km and 400 km and within a threshold distance from each other) may communicate via one or more laser links. Based on the one or more laser links, an anchor satellite of the two or more satellites may perform decoding operations on the data received over the one or more laser links (e.g., FDD time and frequency data associated with waveform and synchronization data from the other satellite(s) based on one or more communications with a terrestrial user device) to generate a synchronized array that is larger than what each of the two or more satellites, individually, would have provided the terrestrial user device. The synchronized array may have an associated uplink and downlink that have different frequency bands. In embodiments, data packets received via the synchronized array uplink may be transmitted.

In some embodiments, an anchor satellite may identify a second satellite and a third satellite for establishing links with. For example, the anchor satellite may establish a link with both the second satellite and the third satellite for receiving time and frequency data (e.g., user device synchronization data) corresponding to communications between each of the satellites and the user device. In embodiments, the anchor satellite receives the time and frequency data from the second satellite via a first laser link between the anchor satellite and the second satellite, and the anchor satellite receives the time and frequency data from the third satellite via a second laser link between the anchor satellite and the third satellite. In some embodiments, the anchor satellite may cause the second satellite and the third satellite to establish a link between the two, and the anchor satellite may receive the time and frequency data based on the link between the second satellite and the third satellite.

The anchor satellite may then generating a synchronized antenna array uplink for the user device based on the data received from the second satellite, from the third satellite, or one or more combinations thereof. In some embodiments, the anchor satellite may generating the synchronized antenna array uplink based on decoding the time and frequency data (e.g., received via the first laser link and the second laser link). The synchronized antenna array uplink may have a higher signal to interference plus noise ratio (SINR) than an associated individual antenna array uplink for each of the anchor satellite, the second satellite, and the third satellite. Further, in embodiments, the anchor satellite may transmit a data packet received from the user device via the synchronized antenna array uplink.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for multi-satellite coordination for enhanced antenna array(s), in accordance with embodiments herein;

FIG. 2 depicts an example block diagram for multi-satellite coordination for enhanced antenna array(s), in accordance with embodiments herein;

FIG. 3 illustrates an example flowchart for multi-satellite coordination for enhanced antenna array(s), in accordance with aspects herein;

FIG. 4 depicts example anchor satellite functionality corresponding to the present technology, in accordance with aspects herein; and

FIG. 5 depicts an example user device and example user device functionality for implementation of the present technology, in accordance with aspects herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

As used herein, the term “direct-to-cell” corresponds to providing a communication service (e.g., text messaging, voice communication coverage, data coverage, network access technology associated with a communication protocol and user device, such as 3G, 4G, 5G, 6G, another generation technology, 802.11x, etc., or one or more combinations thereof) directly to a user device via a satellite without a terrestrial base station.

The term “non-terrestrial device” is distinguished from a terrestrial device on the basis of its lack of ground coupling. Some examples of a non-terrestrial device may include a very low earth orbit satellite, a low earth orbit satellite, a medium earth orbit satellite, a regenerative satellite, a space satellite, a balloon, a dirigible, an airplane, a drone (e.g., an unmanned aerial vehicle), a geosynchronous or geostationary earth orbit satellite, another type of satellite, another type of non-terrestrial device, or one or more combinations thereof.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof”' may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, satellites orbiting the lower altitude ranges (e.g., about 300 km to 400 km) may have uplink budget deficiencies. For example, while orbiting, these satellites may have a particular time window associated with a modulation and coding scheme in which they may provide communication services to a terrestrial user device. As another example, lower orbiting satellites (e.g., Very Low Earth Orbit, Low Earth Orbit or Medium Earth Orbit satellites) may experience higher Doppler shifts compared to higher orbiting satellites, which may cause frequency offsets in an uplink signal associated with signal degradation. Additionally, lower orbiting satellites may experience higher variances, than the higher orbiting satellites, in the differences between received signal power and minimum required signal power for these user device communications (e.g., direct-to-cell). These variances may be based on atmospheric conditions, satellite elevation angle, and the distance between the user device and satellite. As another example, uplink (or downlink) budget deficiencies associated with lower orbiting satellites may be based on the type of antenna (e.g., whether it is a directional antenna and the directionality capabilities of that antenna), the size of the satellite antenna, beamforming capabilities of the antenna, antenna orientation, etc. As an illustration, larger satellite antennas may cause increases to atmospheric drag.

Increasing the antenna array size on one satellite may be limited by payload and satellite antenna size limitations (e.g., Low Earth Orbit (LEO) satellites may have smaller antenna sizes than Geostationary Earth Orbit satellites due to the closer proximity of LEO satellites to Earth). Embodiments of the technology discussed herein provide various improvements to the challenges discussed above. For example, the presently disclosed technology may functionally increase the satellite antenna array size for direct-to-cell communications between terrestrial user devices by utilizing individual arrays from each of a plurality of satellite antennas and establishing a link there between so that the signals received at each satellite array can be added together—increasing diversity gain. The result may improve the uplink budget deficiencies, the downlink budget deficiencies, or both, described above. For example, the resulting larger antenna arrays provided by the technology described herein may have a higher associated signal to interference plus noise ratio (SINR).

In an embodiment, a system for multiple satellite coordination is provided. The system may comprise an anchor satellite, one or more processors associated with the anchor satellite, and computer memory storing computer-usable instructions that, when executed by the one or more processors, cause the one or more processors to perform operations. The operations may comprise identifying a user device and identifying a second satellite capable of receiving an uplink from the user device. The operations may also comprise establishing a link with the second satellite and receiving data from the second satellite based on the link. The operations may also comprise generating a synchronized antenna array uplink for the user device based on the data received from the second satellite. The synchronized antenna array is generated based on combining uplink signals received at an array of each of the anchor satellite and the second satellite, thereby constructively adding those separately received signals in order to increase the diversity gain associated with the synchronized antenna array.

In embodiments, both the anchor satellite and the second satellite may be configured for frequency-division duplexing (FDD) communications with terrestrial user devices via a direct-to-cell implementation. In some embodiments, a third satellite is identified, by the anchor satellite, as being capable of communicating with the user device. Additionally, the anchor satellite may establish a link with the third satellite and receive time and frequency data associated with the third satellite and the user device based on the link with the third satellite. (In some embodiments, more than three satellites are identified by the anchor satellite for link establishment for receiving time and frequency data.) The anchor satellite may generate the synchronized antenna array uplink based on the links among the anchor satellite, the second satellite, and the third satellite, wherein the synchronized antenna array uplink has a higher SINR than the associated individual antenna array uplink for each of the anchor satellite, the second satellite, and the third satellite.

In another embodiment, a method for multiple satellite coordination is provided. The method may comprise identifying, via an anchor satellite capable of communicating with a user device, a second satellite capable of communicating with the user device. The method may also comprise establishing, via the anchor satellite, a link with the second satellite for receiving time and frequency data corresponding to the second satellite and the user device. The method may also comprise generating a synchronized antenna array uplink for the user device based on the time and frequency data received from the second satellite, the synchronized antenna array uplink having a higher signal to interference plus noise ratio (SINR) than an associated individual antenna array uplink for each of the anchor satellite and the second satellite.

In another example embodiment, one or more computer storage media having computer-executable instructions embodied thereon, that when executed by at least one processor, cause the at least one processor to perform a method. The method may comprise identifying, via an anchor non-terrestrial device capable of communicating with a user device, a second non-terrestrial device capable of communicating with the user device. The method may also comprise establishing, via the anchor non-terrestrial device, a link with the second non-terrestrial device for receiving time and frequency data corresponding to the second non-terrestrial device and the user device. The method may also comprise generating a synchronized antenna array uplink for the user device based on the time and frequency data received from the second non-terrestrial device.

In some embodiments, the anchor non-terrestrial device and the second non-terrestrial device are both drones. In some embodiments, the anchor non-terrestrial device and the second non-terrestrial device are both satellites. As an example, the satellites may be orbiting between about 300 kilometers (km) and 400 km. As another example, the satellites may be orbiting a few hundred kilometers up to around 2,000 kilometers above the Earth's surface (e.g., LEO). In yet another example, the satellites may be orbiting a few tens of kilometers to a few hundred kilometers (e.g., Very Low Earth Orbit (VLEO)).

### Example Operating Environments

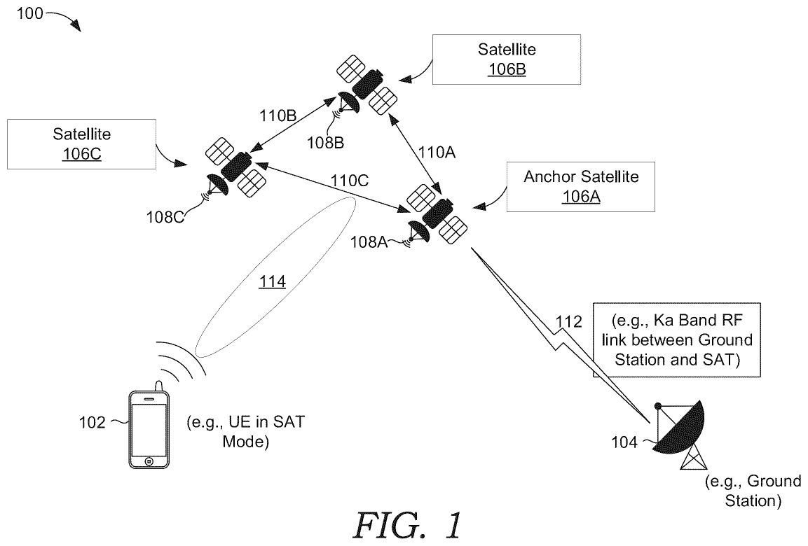

Turning now to FIG. 1, example operating environment 100 is illustrated in accordance with one or more embodiments disclosed herein. At a high level, the example operating environment 100 comprises user device 102, ground station 104, anchor satellite 106A having a first array 108A, a second satellite 106B having a second array 108B, a third satellite 106C having a third array 108C, a first inter-satellite laser link 110A between the anchor satellite 106A and the second satellite 106B, a second inter-satellite laser link 110B between the second satellite 106B and the third satellite 106C, a third inter-satellite laser link 110C between the third satellite 106C and the anchor satellite 106A, link 112 from the ground station 104 to one or more of the anchor satellite 106A, the second satellite 106B, and the third satellite 106C, and synchronized antenna array 114.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional user devices operating in satellite (SAT) mode, one or more terrestrial stations, additional ground stations with links to one or more of the anchor satellite 106A, the second satellite 106B, and the third satellite 106C, more or less satellites, etc.

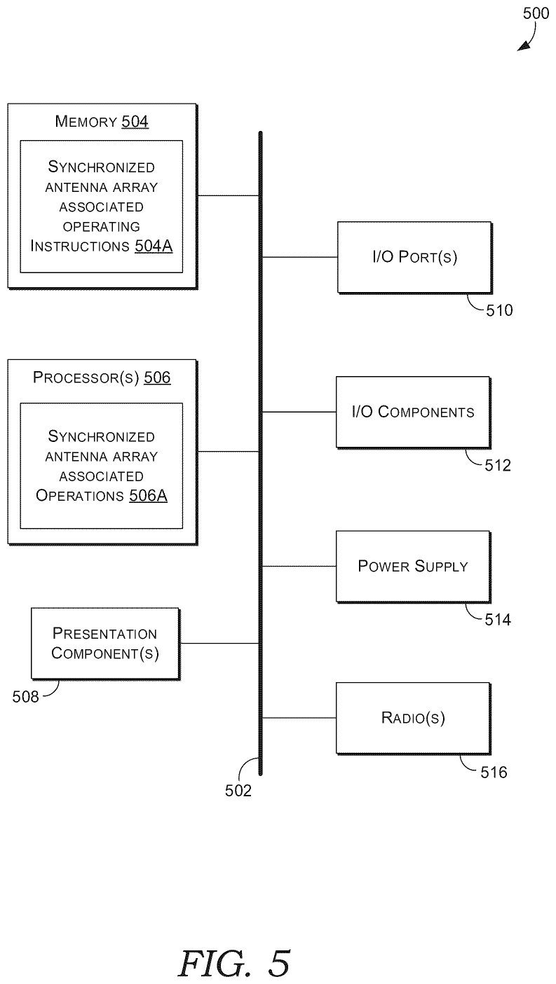

User device 102 may be a device that has the capability of transmitting or receiving one or more signals to or from one or more of the anchor satellite 106A, the second satellite 106B, and the third satellite 106C. In some embodiments, a “user device” may be referred to as a “computing device,” “mobile device,” “user equipment (UE),” or “wireless communication device.” A user device, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating with a satellite. A user device may be, in an embodiment, user device 500 described herein with respect to FIG. 5.

The anchor satellite 106A, the second satellite 106B, or the third satellite 106C may be configured as a non-terrestrial network (e.g., a 3GPP non-terrestrial network) or part of a non-terrestrial network. For example, the non-terrestrial network may be connecting one or more gateways (e.g., ground station 104 comprising one or more devices or a system of components configured to provide an interface between a terrestrial network and the non-terrestrial network) to other network(s). In some embodiments, a coverage beam or antenna array from the anchor satellite 106A via the first array 108A (or from the second satellite 106B via the second array 108B, or from the third satellite 106C via the third array 108C) may not sweep across the ground, and instead remains fixed over a given terrestrial geographical area.

In embodiments, the anchor satellite 106A communicates with the user device 102 via direct-to-cell and also communicates with the ground station 104. In some embodiments, each of the second satellite 106B and the third satellite 106C also communicate with the user device 102 via direct-to-cell (e.g., and are also in communication with ground station 104 or another ground station). For example, link 112 between the anchor satellite 106A and the ground station 104 may be a Ka-band RF link for the establishment of connectivity with the user device 102 and the facilitation of data transmissions to or from the user device 102. In embodiments, the Ka-band RF link refers to a portion of the electromagnetic spectrum with frequencies ranging approximately from 26.5 to 40 GHz. By way of comparison, the Ka-band RF link may correspond to frequencies that provide higher data rates, higher throughput, and greater bandwidth compared to lower frequency bands, such as Ku-band or C-band.

In embodiments, the anchor satellite 106A may identify the second satellite 106B as being capable of communicating with the user device 102, and the anchor satellite 106A may identify the third satellite 106C as being capable of communicating with the user device 102. In some embodiments, the anchor satellite 106A may identify the second satellite 106B and the third satellite 106C for establishing the first inter-satellite laser link 110A between the anchor satellite 106A and the second satellite 106B, the second inter-satellite laser link 110B between the second satellite 106B and the third satellite 106C, the third inter-satellite laser link 110C between the third satellite 106C and the anchor satellite 106A.

In some embodiments, one or more of the anchor satellite 106A, the second satellite 106B, and the third satellite 106C may be configured to operate in the Ka-band frequency range, and the first inter-satellite laser link 110A, second inter-satellite laser link 110B, and the third inter-satellite laser link 110C may be established based on each of the satellites being configured to operate in the Ka-band. For example, the anchor satellite 106A may have transponders (e.g., for receiving uplink signals from the ground station 104, and amplifying and processing the uplink signals, and for transmissions via a downlink to the ground station 104) and communication payloads that are configured to operate in the Ka-band frequency range.

In some embodiments, one or more of the anchor satellite 106A, the second satellite 106B, and the third satellite 106C may establish a radio frequency link with the user device 102 using a Uu interface (e.g., for broadcasting non-terrestrial downlink(s) for one or more communication services to the user device 102, such as 5G services, 6G services, mission critical access, other types of communication services, protocols, or functionality, or one or more combinations thereof). In embodiments, based on one or more communications with the user device 102 (e.g., via the Uu interface), the second satellite 106B may transmit time and frequency data associated with the user device 102 via the first inter-satellite laser link 110A, and the third satellite 106C may transmit time and frequency data associated with the user device 102 via the third inter-satellite laser link 110C. In some embodiments, the second satellite 106B may transmit time and frequency data, in which the third satellite 106C generated based on communications with the user device 102, to the anchor satellite 106A based on the second inter-satellite laser link 110B. In some embodiments, the third satellite 106C may transmit time and frequency data, in which the second satellite 106B generated based on communications with the user device 102, to the anchor satellite 106A based on the second inter-satellite laser link 110B.

In embodiments, the inter-satellite laser links 110A-110C may include optical signals in the form of laser beams for data transmission. For example, the inter-satellite laser links 110A-110C may include one or more optical communication links or optical inter-satellite links to establish communication between the satellites 106A-106C. As another example, the anchor satellite 106A may have one or more laser transmitters for generating one or more laser beams for carrying transmitted data via one or more focused beams. In embodiments, based on establishing the inter-satellite laser links 110A-110C, one or more antenna arrays between the anchor satellite 106A, the second satellite 106B, and the third satellite 106C may be synchronized for providing the synchronized antenna array 114.

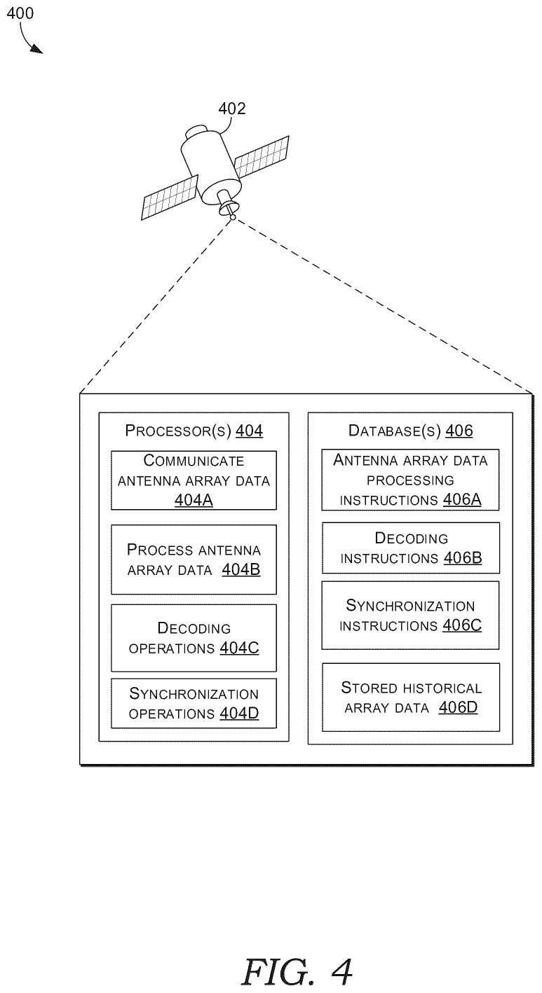

In some embodiments, the synchronized antenna array 114 may be provided based on decoding the time and frequency data that the anchor satellite 106A received from the second satellite 106B via the first inter-satellite laser link 110A and the time and frequency data that the anchor satellite 106A received from the third satellite 106C via the third inter-satellite laser link 110C. In embodiments, the anchor satellite 106A decodes the time and frequency data via the decoding instructions 406B and the decoding operations 404C of FIG. 4. In some embodiments, the synchronized antenna array 114 has a higher signal to interference plus noise ratio than individual antenna array uplinks associated with each of the first array 108A of the anchor satellite 106A, the second array 108B of the second satellite 106B, and the third array 108C of the third satellite 106C. The synchronized antenna array 114 is generated based on combining uplink signals received at each of the first array 108A, the second array 108B, and in some embodiments, also the third array 108C, thereby constructively adding those separately received signals in order to increase the diversity gain for generating the synchronized antenna array 114.

In embodiments, the first array 108A, the second array 108B, and the third array 108C component sizes may be based on the orbiting altitude of each associated satellite, a frequency band corresponding to FDD communications, and link performance associated with the user device 102. In some embodiments, the synchronized antenna array 114 may be generated based on one or more of the orbiting altitude associated with the first array 108A, the second array 108B, and the third array 108C, the frequency band corresponding to FDD communications associated with the first array 108A, the second array 108B, and the third array 108C, and link performance associated with the first array 108A, the second array 108B, and the third array 108C.

In embodiments, the synchronized antenna array 114 may be synchronized based on timing and frequency associated with beams provided individually by each of the first array 108A, second array 108B, and third array 108C. In some embodiments, the synchronized antenna array 114 may be provided based on synchronizing uplink received waveforms from each of the anchor satellite 106A, the second satellite 106B, and the third satellite 106C and based on the anchor satellite 106A processing the uplink received waveforms. In some embodiments, the synchronized antenna array 114 is being provided as the anchor satellite 106A continually process additional uplink received waveforms from one or more of the second satellite 106B and the third satellite 106C.

In embodiments, the synchronized antenna array 114 may be provided to the user device 102 for one or more communication services (e.g., Internet browsing, Wi-Fi, Voice over IP, gaming, High Frequency Trading, SMS, MMS, an emergency medical service, another type of communication service, or one or more combinations thereof). For example, scheduling of the communication services over the synchronized antenna array 114 may be FDD, such that the uplink and downlink transmissions associated with the synchronized antenna array 114 occur on separate frequency bands. For example, the synchronized antenna array 114 may be generated based on processing and decoding FDD synchronization data received over the inter-satellite laser links 110A-110C that corresponds to the user device 102 and the second satellite 106B, the third satellite 106C, or one or more combinations thereof.

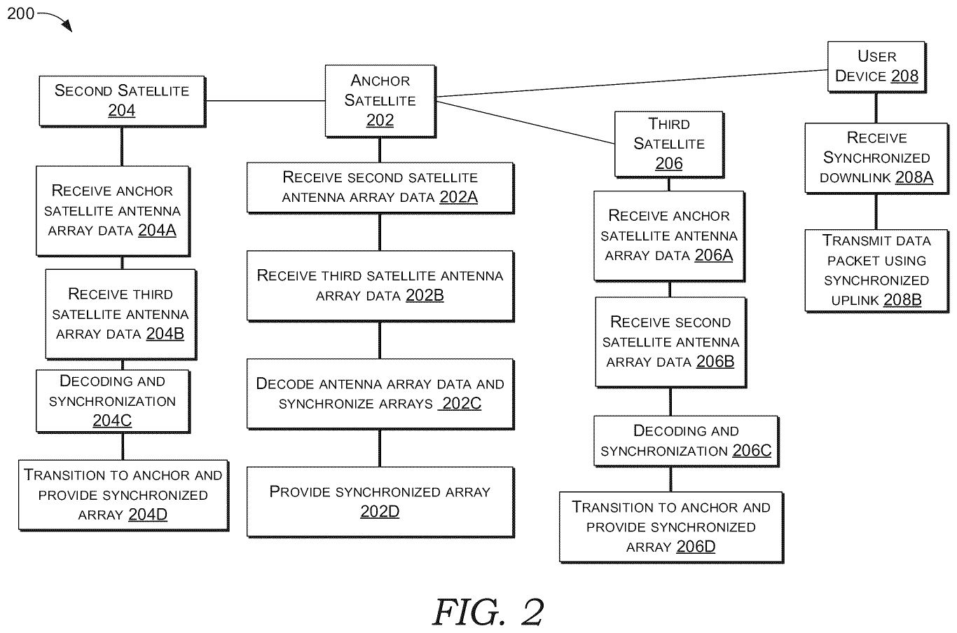

As illustrated in example block diagram 200 of FIG. 2, the anchor satellite 202, second satellite 204, and third satellite 206 perform operations for generating a synchronized antenna array to provide to the user device 208. In some embodiments, the anchor satellite 202 may be anchor satellite 106A of FIG. 1 or anchor satellite 402 of FIG. 4. In some embodiments, the second satellite 204 may be the second satellite 106B of FIG. 1. In some embodiments, the third satellite 206 may be the third satellite 106C of FIG. 1. In some embodiments, the user device 208 may be user device 102 of FIG. 1 or user device 500 of FIG. 5.

The anchor satellite 202 may receive second satellite antenna array data 202A from the second satellite 204 and may also receive third satellite antenna array data 202B from the third satellite 206. In some embodiments, the received second satellite antenna array data 202A may correspond to the second array 108B of the second satellite 106B of FIG. 1. In some embodiments, the received third satellite antenna array data 202B may correspond to the third array 108C of the third satellite 106C of FIG. 1. In some embodiments, the anchor satellite 202 may receive second satellite antenna array data 202A via the first inter-satellite laser link 110A of FIG. 1. In some embodiments, the anchor satellite 202 may receive third satellite antenna array data 202B via the third inter-satellite laser link 110C of FIG. 1.

In some embodiments, the second satellite antenna array data 202A may include FDD time and frequency synchronization data that corresponds to the user device 208 and the second satellite 204. In some embodiments, the third satellite antenna array data 202B may include FDD time and frequency synchronization data that corresponds to the user device 208 and the third satellite 206. In some embodiments, the second satellite antenna array data 202A may include location data (e.g., altitude, latitude, longitude, velocity, positioning, etc.) of the user device 208 received by the second satellite 204. In some embodiments, the third satellite antenna array data 202B may include location data (e.g., altitude, latitude, longitude, velocity, positioning, etc.) of the user device 208 received by the third satellite 206. In some embodiments, the second satellite antenna array data 202A may include a transmission power for the second array 108B of FIG. 1. In some embodiments, the third satellite antenna array data 202B may include a transmission power for the third array 108C of FIG. 1.

The anchor satellite 202 may decode antenna array data (e.g., the received second satellite antenna array data 202A and third satellite antenna array data 202B) to synchronize antenna array uplinks associated with each of the anchor satellite 202, the second satellite 204, and the third satellite 206. In embodiments, the decoding antenna array data and synchronizing antenna arrays 202C may correspond to decoding operations 404C and synchronization operations 404D of FIG. 4. In embodiments, the anchor satellite may provide the synchronized array 202D, such that the synchronized array is a larger array than individual antenna array uplinks provided by each of the anchor satellite 202, the second satellite 204, and the third satellite 206. In some embodiments, the resulting synchronized and larger array has a higher SINR for both uplink and downlink (e.g., associated with providing communication services to the user device 208).

The second satellite 204 may also receive anchor satellite antenna array data 204A from the anchor satellite 202. In embodiments, the second satellite 204 may also receive third satellite antenna array data 204B from the third satellite 206 (e.g., via the second inter-satellite laser link 110B of FIG. 1). Based on the second satellite 204 receiving anchor satellite antenna array data 204A and third satellite antenna array data 204B, the second satellite 204 may also decode and synchronize 204C this data for providing the synchronized and larger array for the user device 208. For example, the synchronized array uplink may have a higher SINR than for individual antenna array uplinks provided by the anchor satellite 202, the second satellite 204, and the third satellite 206 separately. By way of example, in some embodiments, the second satellite 204 may decode and synchronize 204C based on transitioning to the anchor satellite 204D. As another example, the second satellite 204 may provide the synchronized array based on transitioning to the anchor satellite 204D.

The third satellite 206 may also receive anchor satellite antenna array data 206A from the anchor satellite 202. In embodiments, the third satellite 206 may also receive second satellite antenna array data 206B from the second satellite 204 (e.g., via the second inter-satellite laser link 110B of FIG. 1). Based on the third satellite 206 receiving anchor satellite antenna array data 206A and second satellite antenna array data 206B, the third satellite 206 may also decode and synchronize 206C this data for providing the synchronized and larger array for the user device 208. In embodiments, the synchronized array uplink has a higher SINR than for individual antenna array uplinks provided by the anchor satellite 202, the second satellite 204, and the third satellite 206 separately. By way of example, in some embodiments, the third satellite 206 may decode and synchronize 206C based on transitioning to the anchor satellite 206D. As another example, the third satellite 206 may provide the synchronized array based on transitioning to the anchor satellite 206D.

Based on the operations of the anchor satellite 202, the second satellite 204, and the third satellite 206, the user device 208 may receive synchronized downlink(s) 208A associated with the synchronized array from the anchor satellite 202, the second satellite 204, and the third satellite 206. Based on the operations of the anchor satellite 202, the second satellite 204, and the third satellite 206, the user device 208 may transmit one or more data packets using the synchronized uplink 208B. For example, the user device 208 may utilize the synchronized uplink based on the synchronized uplink having a larger SINR than individual uplinks associated with each of the anchor satellite 202, the second satellite 204, and the third satellite 206. In some embodiments, the user device 208 may receive synchronized downlink(s) 208A and utilize the synchronized uplink 208B based on the synchronized antenna array associated operating instructions 504A and synchronized antenna array associated operations 506A of FIG. 5.

### Example Flowchart

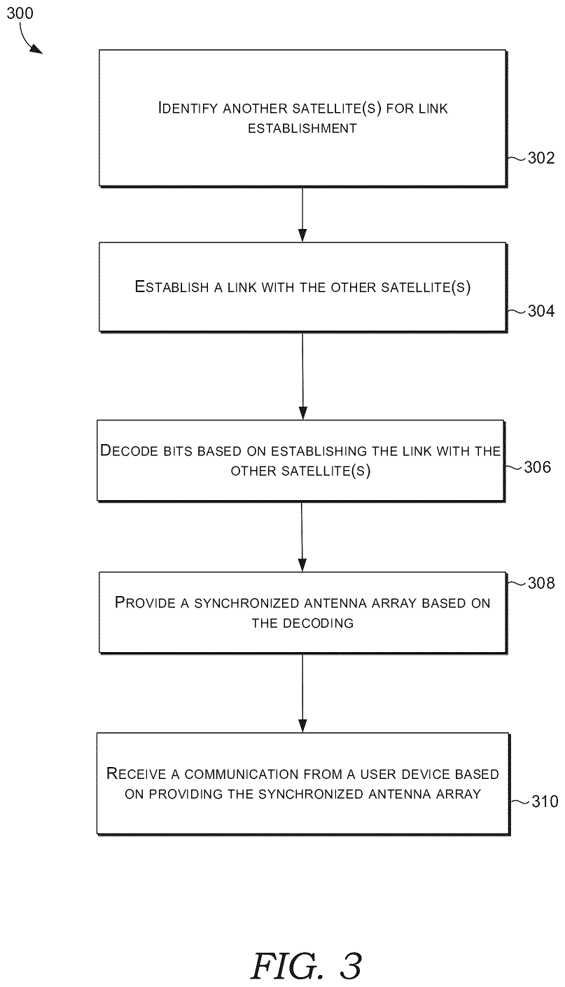

Having described the example embodiments discussed above, an example flowchart is described below with respect to FIG. 3. Example flowchart 300 begins at step 302 with identifying another satellite(s) for link establishment. In embodiments, an anchor satellite (e.g., the anchor satellite 106A of FIG. 1 or the anchor satellite 202 of FIG. 2) may identify one or more of satellites (e.g., the second satellite 106B and the third satellite 106C of FIG. 1, the second satellite 204 and the third satellite 206 of FIG. 2) for link establishment (e.g., via the first inter-satellite laser link 110A, the second inter-satellite laser link 110B, or the third inter-satellite laser link 110C). In embodiments, the anchor satellite may detect these other satellites based on these other satellites being capable of communicating with the user device. In some embodiments, the other satellites may be in the same orbital plane or in different orbital planes. As another example, the anchor satellite may identify the other satellite(s) based on a similar orbiting speed within the same orbital plane as the anchor satellite.

At step 304, the anchor satellite may establish inter-satellite laser links with the other identified satellites, and cause the other satellites to establish inter-satellite links among themselves as well. For instance, the inter-satellite laser links may be established based on a geometric configuration of the constellation associated with each satellite, particular performance parameters of the antennas (e.g., the first array 108A, the second array 108B, and the third array 108C of FIG. 1), the phase difference associated with each of the satellites, an azimuth associated with the antennas, etc., or one or more combinations thereof. To illustrate, the inter-satellite laser link between two satellites may be established based on a spatial position for each of the two satellites and an inter-satellite distance between the two.

In embodiments, the anchor satellite (e.g., the anchor satellite 106A of FIG. 1) may transmit one or more requests to one or more other satellites, based on the inter-satellite laser links established, for time and frequency data associated with a particular user device. Based on the request(s), the anchor satellite may receive data from the other satellite(s) based on the other satellite(s) communicating with the user device. For instance, the anchor satellite may receive waveform and synchronization data associated with the other satellite and the user device, such as a quadrature phase shift keying modulation scheme, an eight-phase shift keying scheme, a quadrature amplitude modulation, preamble synchronization data, frame synchronization data, timing and frequency synchronization data associated with the other satellite and the user device and corresponding to FDD communications, user device location data (e.g., altitude, latitude, longitude, velocity, positioning, etc.) received by the other satellite, space-time block coding data for signal transmissions between the other satellite and the UE, antenna characteristics associated with the other satellite or the user device that the other satellite received, a transmission power of the other satellite and the user device, signal strength of the transmissions received by the other satellite from the user device, signal strength of the transmissions received by the user device from the other satellite, timing between transmissions sent by the other satellite and received by the user device, timing between transmissions sent by the user device and received by the other satellite, a distance between the other satellite and the user device, timing associated with each of the other types of data (e.g., a timestamp associated with the signal strength, a timestamp associated with the user device location data), other control signals corresponding to the other satellite and the user device, channel access data associated with the user device and the other satellite, other types of data corresponding to transmissions between the user device and the other satellite, etc., or one or more combinations thereof.

At step 306, the anchor satellite performs decoding based on the inter-satellite laser links established with the other satellites. For example, the anchor satellite may decode the information received via the inter-satellite laser link(s) (e.g., via the first inter-satellite laser link 110A, the second inter-satellite laser link 110B, or the third inter-satellite laser link 110C of FIG. 1) based on the one or more requests to the one or more other satellites. For instance, the information received via the inter-satellite laser link(s) (e.g., the waveform and synchronization data associated with the other satellite and the user device) may be modulated and encoded, and the anchor satellite may process the corresponding bits (e.g., via the one or more processors 404 of FIG. 4). In some embodiments, the anchor satellite performs demodulation, error correction, bit decoding, packet de-multiplexing, protocol decoding, payload extraction, digital signal processing using one or more digital signal processing algorithms (e.g., channel estimation, equalization, symbol timing recovery, and payload processing), etc., or one or more combinations thereof, so that a synchronized array may be generated from the information received via the inter-satellite laser link(s) (e.g., the received space-time block coding data for signal transmissions between the other satellite(s) and the UE, antenna characteristics associated with the other satellite(s), etc.).

At step 308, the synchronized antenna array may be provided based on the decoding of the information received by the anchor satellite via the inter-satellite laser link(s) with the other satellite(s). In embodiments, the synchronized antenna array is generated based on combining decoded uplink signals received at a plurality of satellites, thereby constructively adding those separately decoded signals in order to increase the diversity gain for generating the synchronized antenna array. For example, the synchronized antenna array(s) (based on this decoding) may have a higher signal to interference plus noise ratio (SINR) than an associated individual antenna array for each of the anchor satellite and the other satellite(s). In embodiments, the synchronized antenna array(s) may be provided as a downlink to a user device. In some embodiments, the synchronized antenna array(s) may be provided to the user device for transmitting a data packet received from the user device via the synchronized antenna array uplink, wherein the synchronized antenna array uplink has a higher SINR than an individual uplink associated with the anchor satellite and the other satellite(s). For example, at step 310, one or more of the anchor satellite and the other satellite(s) may receive a communication from the user device based on providing the synchronized antenna array(s) (e.g., via the uplink for transmission of the data packet).

In some embodiments, after the synchronized antenna array(s) is provided, one or more of the anchor satellite or the other satellite(s) may receive location data (e.g., location data associated with a later time after the synchronized antenna array(s) is provided) for the user device. In some embodiments, after the synchronized antenna array(s) is provided, one or more of the anchor satellite or the other satellite(s) may receive additional information via the inter-satellite laser link(s) (e.g., an additional signal strength of a transmission received by one of the satellites from the user device, a signal strength of a transmission received by the user device from the synchronized antenna array(s), additional time and frequency data of the associated individual antenna array of one of the other satellites and the user device, etc.). Based on receiving the location data associated with a later time after the synchronized antenna array(s) is provided, the additional time and frequency data of the associated individual antenna array of one of the other satellites and the user device, etc., the anchor satellite may determine that one of the other satellites (e.g., the second satellite 106B of FIG. 1) is to transition to the anchor satellite. Based on determining that the other satellite is to transition to the anchor satellite, the anchor satellite may transmit (e.g., via the inter-satellite laser link(s)) a set of time and frequency data associated with the user device to the second satellite. For example, the set of time and frequency data may correspond to the synchronized antenna array(s) provided to the user device. In some embodiments, the set of time and frequency data may include preamble synchronization data, frame synchronization data, FDD time and frequency synchronization data associated with the anchor satellite and the user device, demodulated data associated with the synchronized antenna array(s), etc., or one or more combinations thereof.

### Example Anchor Satellite

Referring now to FIG. 4, example diagram 400 is depicted of an example anchor satellite functionality suitable for use in implementations of the present disclosure. Example diagram 400 including anchor satellite 402 is but one example of suitable anchor satellite functionality and is not intended to suggest any limitation as to the scope of use or functionality of the invention. Neither should example anchor satellite 402 be interpreted as having any dependency or requirement relating to any one or combination of components illustrated. In some embodiments, the anchor satellite 402 is the same as or similar to anchor satellite 106A of FIG. 1 or anchor satellite 202 of FIG. 2.

Example diagram 400 includes anchor satellite 402 having one or more processors 404 and one or more databases 406. Some functionality of the one or more processors 404 may include communicating antenna array data 404A, processing antenna array data 404B, decoding operations 404C, and synchronization operations 404D. The one or more databases 406 may include antenna array data processing instructions 406A, decoding instructions 406B, synchronization instructions 406C, and stored historical array data 406D.

In some embodiments, the anchor satellite 402 may be orbiting between about 300 kilometers (km) and 400 km. As another example, the anchor satellite 402 may be a LEO satellite, a VLEO satellite, or another type of satellite. In some embodiments, the anchor satellite 402 is configured for direct-to-cell FDD communications with user devices. In other embodiments, the anchor satellite 402 may be another type of non-terrestrial device, such as a balloon, a dirigible, an airplane, a drone (e.g., an unmanned aerial vehicle), a geosynchronous or geostationary earth orbit satellite, etc., or one or more combinations thereof.

In some embodiments, the one or more processors 404 may include a radiation-hardened processor, a field-programmable gate array, a system-on-chip processor, a radiation-tolerant microcontroller, a digital signal processor, an application-specific integrated circuit, a quad-core and multi-core processor, a PowerPC processor, another type of non-terrestrial processor, or one or more combinations thereof. In some embodiments, the one or more processors 404 may also have memory. In addition, in some embodiments, the one or more databases 406 may include radiation-hardened memory, flash memory, erasable programmable read-only memory, solid-state drives, ferroelectric radio access memory, magnetic random-access memory, onboard data storage systems, file systems, other types of non-terrestrial memory, or one or more combinations thereof.

The antenna array data processing instructions 406A may be used by the one or more processors 404 to cause the one or more processors 404 to perform one or more of communicating antenna array data 404A, processing antenna array data 404B, another type of processor functionality, or one or more combinations thereof. For example, communicating antenna array data 404A may include communicating the antenna array data 404A corresponding to the anchor satellite 402 to another satellite via one or more terrestrial network components or non-terrestrial network components, receiving the antenna array data corresponding to another satellite via one or more terrestrial network components (e.g., ground station 104 of FIG. 1) or non-terrestrial network components, etc., or one or more combinations thereof. As another example, the antenna array data processing instructions 406A may be used by the one or more processors 404 to cause the one or more processors 404 to process antenna array data 404B received by the other satellite(s) based on establishing one or more inter-satellite laser links with the other satellite(s).

Example antenna array data processing instructions 406A may include identifying a second satellite (as well as other satellites) within a threshold distance from the anchor satellite 402. As another example, the anchor satellite 402 may be capable of communicating with a user device, and the second satellite within the threshold distance from the anchor satellite 402 may be identified as also being capable of communicating with the user device. In other embodiments, an anchor non-terrestrial device capable of communicating with a user device (e.g., a drone), may identify a second non-terrestrial device within a threshold distance from the anchor non-terrestrial device for antenna array synchronization.

In embodiments, one or more other satellites may be identified based on receiving antenna array data 404A associated with the other satellite(s), the antenna array data 404A including a geometric configuration of the constellation associated with the other satellite. In some embodiments, the other satellite(s) may be identified based on the antenna array data 404A of the anchor satellite 402 and the other satellite(s), such as particular performance parameters of the antennas of the anchor satellite 402 and the associated performance parameters of the antennas of the other satellite(s), the phase difference associated with the antennas of each of the anchor satellite 402 and the other satellite(s), an azimuth associated with the antennas, a spatial position associated with the antennas, an inter-satellite distance between the anchor satellite 402 and the other satellite(s), etc., or one or more combinations thereof.

Based on establishing one or more links (e.g., inter-satellite laser links) with the one or more other satellite(s) identified by the anchor satellite 402, the anchor satellite 402 may perform, via the one or more processors 404, processing antenna array data 404B. In embodiments, the anchor satellite 402 may receive time and frequency data over an inter-satellite laser link, the time and frequency data corresponding to a second satellite and the user device. For example, the processing antenna array data 404B may correspond to the time and frequency data, such as a quadrature phase shift keying modulation scheme associated with the second satellite and the user device, a quadrature amplitude modulation scheme associated with the second satellite and the user device, FDD synchronization data associated with the other satellite and the user device, user device location data (e.g., altitude, latitude, longitude, velocity, positioning, etc.) received by the other satellite, space-time block coding data for signal transmissions between the second satellite and the user device, a signal strength of a transmission received by the other satellite from the user device, etc., or one or more combinations thereof.

In some embodiments, processing antenna array data 404B may include the processing of signal relay(s) received from the user device (e.g., a terrestrial user device) via an individual uplink provided by the second satellite. In some embodiments, processing antenna array data 404B may include determining a frequency or bandwidth associated with one or more of the anchor satellite individual uplink, an anchor satellite individual downlink, anchor satellite individual uplink, another satellite individual downlink, etc., or one or more combinations thereof. In some embodiments, processing antenna array data 404B may include determining a signal to interference plus noise ratio (SINR) associated with an antenna array provided by the anchor satellite 402 or another satellite, signal to noise ratio associated with an antenna array provided by the anchor satellite 402 or another satellite, another type of interference or signal strength measurement associated with an antenna array provided by the anchor satellite 402 or another satellite, etc., or one or more combinations thereof.

The decoding instructions 406B may be used by the one or more processors 404 to cause the one or more processors 404 to perform one or more of decoding operations 404C, synchronization operations 404D, another type of processor functionality, or one or more combinations thereof. Example decoding operations 404C may include decoding bits of the time and frequency data received over an inter-satellite laser link. In embodiments, decoding operations 404C may include demodulation, error correction, bit decoding, packet de-multiplexing, protocol decoding, payload extraction, digital signal processing, etc., or one or more combinations thereof, of the time and frequency data received over an inter-satellite laser link.

The synchronization instructions 406C may be used by the one or more processors 404 to cause the one or more processors 404 to perform one or more of synchronization operations 404D, another type of processor functionality, or one or more combinations thereof. The synchronization operations 404D may be performed based on the decoding operations 404C. In embodiments wherein the anchor satellite 402 determines that another satellite is to transition to the anchor satellite, the anchor satellite 402 may communicate one or more of the stored historical array data 406D associated with the synchronization operations 404D to the other satellite determined to be the next anchor satellite.

The synchronization operations 404D may include, in some embodiments, providing the synchronized one or more antenna arrays as a downlink to one or more user devices based on establishing a link with the second satellite. In some embodiments, the synchronization operations 404D may include providing the synchronized one or more antenna arrays that have a higher SINR than an associated individual antenna array for each of the anchor satellite 402 and the second satellite or providing a synchronized antenna array using the antenna arrays of a second satellite and a third satellite, such that the synchronized antenna array has a higher SINR than the associated individual antenna array for each of the anchor satellite 402, the second satellite, and the third satellite. In some embodiments, the synchronization operations 404D may include transmitting a data packet received from one or more user devices via an uplink based on synchronizing the antenna arrays between the anchor satellite 402 and one or more other satellites, wherein the uplink has a higher SINR than an individual uplink associated with the anchor satellite and the other satellite(s).

In embodiments, the one or more processors 404 may perform one or more of communicating antenna array data 404A, processing antenna array data 404B, decoding operations 404C, synchronization operations 404D, another type of processor functionality, or one or more combinations thereof, based on stored historical array data 406D. For example, the stored historical array data 406D may include the data associated with identifying other satellites to establish inter-satellite links with, the antenna array data received over the inter-satellite link(s), the decoded antenna array data, etc., or one or more combinations thereof.

### Example User Device

Referring now to FIG. 5, a diagram is depicted of an example user device suitable for use in implementations of the present disclosure. In particular, the example computer environment is shown and designated generally as user device 500. User device 500 is but one example of a suitable computing environment and is not intended to suggest any limitation as to the scope of use or functionality of the invention. Neither should user device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, user device 500 includes bus 502 that directly or indirectly couples the following devices: memory 504, one or more processors 506, one or more presentation components 508, input/output (I/O) ports 510, I/O components 512, power supply 514 and radio(s) 516. The memory 504 may include synchronized antenna array associated operating instructions 504A, which may be executed by the processor(s) 506 to perform synchronized antenna array associated operations 506A.

Although the components of FIG. 5 are shown with lines for the sake of clarity, in reality, delineating various components is not so clear, and metaphorically, the lines would more accurately be grey and fuzzy. For example, one may consider a presentation component, such as a display device to be one of I/O components 512. As another example, processors, such as one or more processors 506, have memory. The present disclosure hereof recognizes that such is the nature of the art, and reiterates that FIG. 5 is merely illustrative of an example computing environment for a user device that may be used in connection with one or more implementations of the present disclosure. Additionally, distinction is not made between such categories as “workstation,” “server,” “laptop,” “handheld device,” etc., as all are contemplated within the scope of FIG. 5 and refer to “computer” or “computing device.” In yet another example, bus 502 may represent what may be one or more busses (such as an address bus, data bus, or combination thereof).

User device 500 typically includes a variety of computer-readable media. Computer-readable media may be any available media that may be accessed by user device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 504 includes computer-storage media in the form of volatile and/or nonvolatile memory. Memory 504 may be removable, non-removable, or a combination thereof. Examples of memory 504 may include solid-state memory, hard drives, optical-disc drives, etc., or one or more combinations thereof. The synchronized antenna array associated operating instructions 504A stored in memory 504 may be used by the one or more processors 506 to cause the one or more processors 506 to perform synchronized antenna array associated operations 506A. In some embodiments, the synchronized antenna array associated operations 506A may include receive synchronized downlink 208A and transmit data packet using synchronized uplink 208B of FIG. 2.

User device 500 also includes one or more processors 506 that read data from various entities, such as bus 502, memory 504, or I/O components 512. Examples of one or more processors 506 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors or other suitable hardware configured to perform synchronized antenna array associated operations 506A using the synchronized antenna array associated operating instructions 504A, or one or more combinations thereof.

In some embodiments, the synchronized antenna array associated operations 506A may include transmitting voice data to an anchor satellite based on a synchronized uplink, transmitting packet data to an anchor satellite based on a synchronized uplink, transmitting location data to an anchor satellite based on a synchronized uplink, transmitting multimedia data to an anchor satellite based on a synchronized uplink, etc., or one or more combinations thereof. In some embodiments, the synchronized antenna array associated operations 506A may include transmitting timing and synchronization signals, control signals, etc., or one or more combinations thereof, to an anchor satellite based on the anchor satellite establishing a link with another satellite or based on the anchor satellite establishing a synchronized array in response to decoding antenna array data from the other satellite. In some embodiments, the user device 500 may transmit the location data to the anchor satellite continuously after a predetermined threshold period of time or upon the user device 500 determining that the location data has changed. By way of example, the anchor satellite may use this updated location data to adjust a synchronized array or so that another satellite may transition to the anchor.

One or more presentation components 508 may present (e.g., to a person or other device) data indications (e.g., the synchronized antenna array associated operating instructions 504A). Examples of the one or more presentation components 508 may include a display device, speaker, printing component, vibrating component, etc. I/O ports 510 may allow user device 500 to be logically coupled to I/O components 512 or other devices. In some embodiments, only a portion of a plurality of I/O components 512 may be built into user device 500. Illustrative I/O components 512 may include a microphone, joystick, game pad, satellite dish, scanner, printer, wireless device, etc., or one or more combinations thereof. In some embodiments, the one or more presentation components 508 may provide an indication (e.g., via the display or vibrating component) that the user device 500 is performing the synchronized antenna array associated operations 506A.

Radio 516 may represent a radio that facilitates communication with a wireless telecommunications network. Illustrative wireless telecommunications technologies may include CDMA, GPRS, TDMA, GSM, and the like. Radio 516 might additionally or alternatively facilitate other types of wireless communications including Wi-Fi, WiMAX, LTE, or other VOIP communications. As can be appreciated, in various embodiments, radio 516 may be configured to support multiple technologies and/or multiple radios may be utilized to support multiple technologies. By way of example, the radio 516 may be configured to support an 8-element MIMO antenna configuration for 5G smartphones or another number of elements for various antenna configurations for other generation smartphones or user devices for implementing synchronized antenna array associated operations 506A.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for multiple satellite coordination, the system comprising:
an anchor satellite;
one or more processors associated with the anchor satellite; and
computer memory storing computer-usable instructions that, when executed by the one or more processors, cause the one or more processors to perform operations comprising:
identifying a user device;
identifying a second satellite capable of receiving an uplink from the user device;
establishing a link with the second satellite;
receiving data from the second satellite based on the link; and
generating a synchronized antenna array uplink for the user device based on the data received from the second satellite.

2. The system according to claim 1, wherein the synchronized antenna array uplink has a higher signal to interference plus noise ratio (SINR) than an associated individual antenna array uplink for each of the anchor satellite and the second satellite.

3. The system according to claim 2, the operations further comprising:
identifying a third satellite capable of communicating with the user device;
establishing a link with the third satellite for receiving time and frequency data associated with one or more communications between the third satellite and the user device;
causing the second satellite and the third satellite to establish a link between the second satellite and the third satellite; and
generating the synchronized antenna array uplink based on the links among the anchor satellite, the second satellite, and the third satellite, wherein the synchronized antenna array uplink has a higher SINR than the associated individual antenna array uplink for each of the anchor satellite, the second satellite, and the third satellite.

4. The system according to claim 2, the operations further comprising:
transmitting a data packet received from the user device via the synchronized antenna array uplink.

5. The system according to claim 2, the operations further comprising:
based on the link with the second satellite, receiving, from the second satellite, time and frequency data associated with the associated individual antenna array uplink between the second satellite and the user device;
decoding the time and frequency data; and
generating the synchronized antenna array uplink based on decoding the time and frequency data.

6. The system according to claim 5, the operations further comprising:
after generating the synchronized antenna array uplink, receiving location data for the user device and additional time and frequency data from the second satellite;
determining, based on the additional time and frequency data and the location data for the user device, that the second satellite is to transition to the anchor satellite; and
based on determining that the second satellite is to transition to the anchor satellite, transmitting a set of time and frequency data associated with the user device to the second satellite.

7. The system according to claim 5, wherein the time and frequency data received from the second satellite includes synchronization data between the second satellite and the user device.

8. A method for multiple satellite coordination, the method comprising:
identifying, via an anchor satellite capable of communicating with a user device, a second satellite capable of communicating with the user device;
establishing, via the anchor satellite, a link with the second satellite for receiving time and frequency data corresponding to the second satellite and the user device; and
generating a synchronized antenna array uplink for the user device based on the time and frequency data received from the second satellite, the synchronized antenna array uplink having a higher signal to interference plus noise ratio (SINR) than an associated individual antenna array uplink for each of the anchor satellite and the second satellite.

9. The method according to claim 8, further comprising:
identifying, via the anchor satellite, a third satellite capable of communicating with the user device;
establishing, via the anchor satellite, a link with the third satellite for receiving time and frequency data corresponding to the third satellite and the user device; and
generating the synchronized antenna array uplink based on the time and frequency data received from the third satellite, the synchronized antenna array uplink having a higher SINR than the associated individual antenna array uplink for the third satellite.

10. The method according to claim 9, further comprising:
decoding the time and frequency data corresponding to communications between the second satellite and the user device;
decoding the time and frequency data corresponding to communications between the third satellite and the user device; and
generating the synchronized antenna array uplink based on the decoding.

11. The method according to claim 10, further comprising:
after generating the synchronized antenna array uplink:
receiving a first set of additional time and frequency data based on a communication between the associated individual antenna array uplink of the second satellite and the user device; and
receiving a second set of additional time and frequency data based on a communication between the associated individual antenna array uplink of the third satellite and the user device;
determining, based on the first set of additional time and frequency data and the second set of additional time and frequency data, that the second satellite is to transition to the anchor satellite; and
based on determining that the second satellite is to transition to the anchor satellite, transmitting additional time and frequency data associated with the user device to the second satellite.

12. The method according to claim 9, further comprising causing the second satellite and the third satellite to establish a link between the second satellite and the third satellite and generating the synchronized antenna array uplink based on the link between the second satellite and the third satellite.

13. The method according to claim 8, wherein the time and frequency data received from the second satellite includes synchronization data between the second satellite and the user device.

14. One or more computer storage media having computer-executable instructions embodied thereon, that when executed by at least one processor, cause the at least one processor to perform a method comprising:
identifying, via an anchor non-terrestrial device capable of communicating with a user device, a second non-terrestrial device capable of communicating with the user device;
establishing, via the anchor non-terrestrial device, a link with the second non-terrestrial device for receiving time and frequency data corresponding to the second non-terrestrial device and the user device; and
generating a synchronized antenna array uplink for the user device based on the time and frequency data received from the second non-terrestrial device.

15. The one or more computer storage media of claim 14, wherein the anchor non-terrestrial device and the second non-terrestrial device are both drones.

16. The one or more computer storage media of claim 15, wherein the synchronized antenna array uplink has a higher uplink signal to interference plus noise ratio than an associated individual uplink for each of the drones.

17. The one or more computer storage media of claim 14, wherein the anchor non-terrestrial device and the second non-terrestrial device are both satellites.

18. The one or more computer storage media of claim 17, wherein the satellites are orbiting between about 300 kilometers (km) and 400 km.

19. The one or more computer storage media of claim 18, wherein the synchronized antenna array uplink has a higher uplink signal to interference plus noise ratio (SINR) than an associated individual uplink for each of the satellites.

20. The one or more computer storage media of claim 19, further comprising transmitting a data packet received from the user device via the synchronized antenna array uplink.
